(19) United States
(12) Patent Application Publication
(10) Pub. No.: US 2013/0194198 A1
(43) Pub. Date: Aug. 1, 2013

(54) Thin Dielectric Layer For Touch Sensor Stack

(71) Applicants: David Brent Guard, Southampton (GB); Jalil Shaikh, Fremont, CA (US)

(72) Inventors: David Brent Guard, Southampton (GB); Jalil Shaikh, Fremont, CA (US)

(21) Appl. No.: 13/364,057

(22) Filed: Feb. 1, 2012

(51) Int. Cl. G06F 3/041

(52) U.S. Cl. 345/173

(57) ABSTRACT

In one embodiment, a method for forming a touch sensor is provided. The method includes forming a substrate and a plurality of electrodes comprising one or more conductive materials on a first surface of the substrate. The method further includes forming a dielectric layer that is less than 40 microns thick over the plurality of electrodes and at least a portion of the first surface of the substrate, with no adhesive layer placed between the dielectric layer and the plurality of electrodes.

### TECHNICAL FIELD

This disclosure generally relates to touch sensors.

### BACKGROUND

A touch sensor may detect the presence and location of a touch or the proximity of an object (such as a user's finger or a stylus) within a touch-sensitive area of the touch sensor overlaid on a display screen, for example. In a touch-sensitive-display application, the touch sensor may enable a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch sensors, such as (for example) resistive touch screens, surface acoustic wave touch screens, and capacitive touch screens. Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A touch-sensor controller may process the change in capacitance to determine its position on the touch screen.

### BRIEF DESCRIPTION OF THE DRAWINGS

FIG. 1 illustrates an example touch sensor with an example touch-sensor controller.

FIG. 2a illustrates an example thin dielectric layer formed on a top surface of an example substrate with conductive material forming electrodes.

FIG. 2b illustrates a display and an example stack of a touch sensor that incorporates the thin dielectric layer of FIG. 2a.

FIG. 3a illustrates another example thin dielectric layer formed on a bottom surface of an example substrate with conductive material forming electrodes.

FIG. 3b illustrates a display and an example stack of a touch sensor that incorporates the thin dielectric layer of FIG. 3a.

FIG. 4a illustrates example thin dielectric layers formed on the top and bottom surfaces of an example substrate with conductive material forming electrodes.

FIG. 4b illustrates a display and an example stack of a touch sensor that incorporates the thin dielectric layers of FIG. 4a.

FIG. 5 illustrates an example method for forming a stack of a touch sensor with one or more thin dielectric layers.

### DESCRIPTION OF EXAMPLE EMBODIMENTS

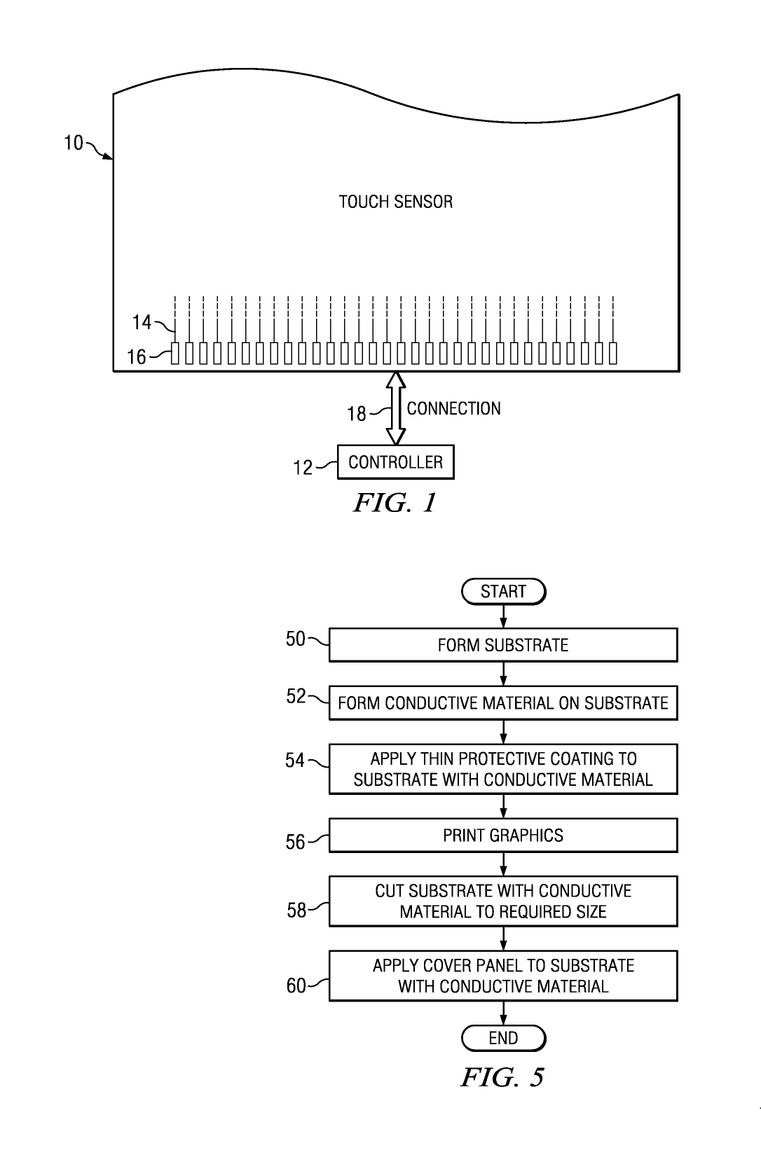

FIG. 1 illustrates an example touch sensor 10 with an example touch-sensor controller 12. Touch sensor 10 and touch-sensor controller 12 may detect the presence and location of a touch or the proximity of an object within a touch-sensitive area of touch sensor 10. Herein, reference to a touch sensor may encompass both the touch sensor and its touch-sensor controller, where appropriate. Similarly, reference to a touch-sensor controller may encompass both the touch-sensor controller and its touch sensor, where appropriate. Touch sensor 10 may include one or more touch-sensitive areas, where appropriate. Touch sensor 10 may include an array of drive and sense electrodes (or an array of electrodes of a single type) disposed on one or more substrates, which may be made of a dielectric material. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode (whether a drive electrode or a sense electrode) may be an area of conductive material forming a shape, such as for example a disc, square, rectangle, thin line other suitable shape, or suitable combination of these. One or more cuts in one or more layers of conductive material may (at least in part) create the shape of an electrode, and the area of the shape may (at least in part) be bounded by those cuts. In particular embodiments, the conductive material of an electrode may occupy approximately 100% of the area of its shape. As an example and not by way of limitation, an electrode may be made of indium tin oxide (ITO) and the ITO of the electrode may occupy approximately 100% of the area of its shape (sometimes referred to as 100% fill), where appropriate. In particular embodiments, the conductive material of an electrode may occupy substantially less than 100% of the area of its shape. As an example and not by way of limitation, an electrode may be made of fine lines of metal or other conductive material (FLM), such as for example copper, silver, or a copper- or silver-based material, and the fine lines of conductive material may occupy approximately 5% of the area of its shape in a hatched, mesh, or other suitable pattern. Herein, reference to FLM encompasses such material, where appropriate. Although this disclosure describes or illustrates particular electrodes made of particular conductive material forming particular shapes with particular fills having particular patterns, this disclosure contemplates any suitable electrodes made of any suitable conductive material forming any suitable shapes with any suitable fill percentages having any suitable patterns.

Where appropriate, the shapes of the electrodes (or other elements) of a touch sensor may constitute in whole or in part one or more macro-features of the touch sensor. One or more characteristics of the implementation of those shapes (such as, for example, the conductive materials, fills, or patterns within the shapes) may constitute in whole or in part one or more micro-features of the touch sensor. One or more macro-features of a touch sensor may determine one or more characteristics of its functionality, and one or more micro-features of the touch sensor may determine one or more optical features of the touch sensor, such as transmittance, refraction, or reflection.

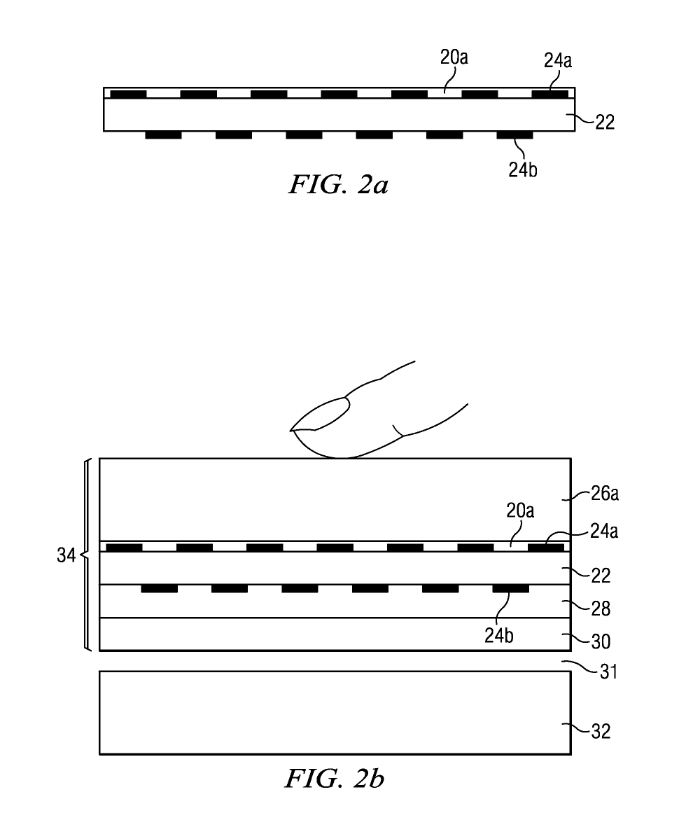

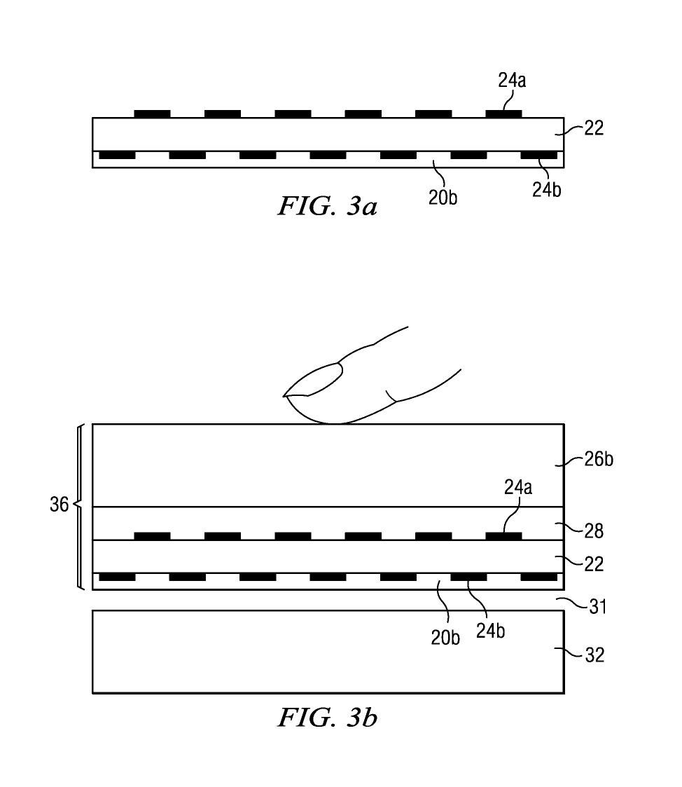

A mechanical stack may contain the substrate (or multiple substrates) and the conductive material forming the drive or sense electrodes of touch sensor 10. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. As an alternative, where appropriate, a thin coating of a dielectric material may be disposed between the cover panel and the substrate with the conductive material forming the drive or sense electrodes and the cover panel may be formed on the thin dielectric layer through an in-mold lamination (IML) process (described in further detail in connection with FIGS. 2a and 2b). The mechanical stack may also include a second layer of OCA and a dielectric layer (which may be made of PET or another suitable material, similar to the substrate with the conductive material forming the drive or sense electrodes). As an alternative, where appropriate, a thin coating of a dielectric material may be applied instead of the second layer of OCA and the dielectric layer (described in further detail in connection with FIGS. 3a and 3b). The second layer of OCA may be disposed between the substrate with the conductive material making up the drive or sense electrodes and the dielectric layer, and the dielectric layer may be disposed between the second layer of OCA and an air gap to a display of a device including touch sensor 10 and touch-sensor controller 12. As an example only and not by way of limitation, the cover panel may have a thickness of approximately 1 mm; the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; the dielectric layer may have a thickness of approximately 0.05 mm; and the thin coating of dielectric material may have a thickness of between approximately 0.5 μm and approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

One or more portions of the substrate of touch sensor 10 may be made of polyethylene terephthalate (PET) or another suitable material. This disclosure contemplates any suitable substrate with any suitable portions made of any suitable material. In particular embodiments, the drive or sense electrodes in touch sensor 10 may be made of ITO in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness between approximately 0.5 μm and approximately 5 μm and a width between approximately 1 μm and approximately 10 μm. As another example, one or more portions of the conductive material may be silver or silver-based and similarly have a thickness between approximately 1 μm and approximately 5 μm and a width between approximately 1 μm and approximately 10 μm. This disclosure contemplates any suitable electrodes made of any suitable material.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a space between them. A pulsed or alternating voltage applied to the drive electrode (by touch-sensor controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and touch-sensor controller 12 may measure the change in capacitance. By measuring changes in capacitance throughout the array, touch-sensor controller 12 may determine the position of the touch or proximity within the touch-sensitive area(s) of touch sensor 10.

In a self-capacitance implementation, touch sensor 10 may include an array of electrodes of a single type that may each form a capacitive node. When an object touches or comes within proximity of the capacitive node, a change in self-capacitance may occur at the capacitive node and touch-sensor controller 12 may measure the change in capacitance, for example, as a change in the amount of charge needed to raise the voltage at the capacitive node by a pre-determined amount. As with a mutual-capacitance implementation, by measuring changes in capacitance throughout the array, touch-sensor controller 12 may determine the position of the touch or proximity within the touch-sensitive area(s) of touch sensor 10. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have drive and sense electrodes disposed in a pattern on one side of a single substrate. In such a configuration, a pair of drive and sense electrodes capacitively coupled to each other across a space between them may form a capacitive node. For a self-capacitance implementation, electrodes of only a single type may be disposed in a pattern on a single substrate. In addition or as an alternative to having drive and sense electrodes disposed in a pattern on one side of a single substrate, touch sensor 10 may have drive electrodes disposed in a pattern on one side of a substrate and sense electrodes disposed in a pattern on another side of the substrate. Moreover, touch sensor 10 may have drive electrodes disposed in a pattern on one side of one substrate and sense electrodes disposed in a pattern on one side of another substrate. In such configurations, an intersection of a drive electrode and a sense electrode may form a capacitive node. Such an intersection may be a location where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Touch-sensor controller 12 may detect and process the change in capacitance to determine the presence and location of the touch or proximity input. Touch-sensor controller 12 may then communicate information about the touch or proximity input to one or more other components (such one or more central processing units (CPUs)) of a device that includes touch sensor 10 and touch-sensor controller 12, which may respond to the touch or proximity input by initiating a function of the device (or an application running on the device). Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 12 may be one or more integrated circuits (ICs), such as for example general-purpose microprocessors, microcontrollers, programmable logic devices or arrays, application-specific ICs (ASICs). In particular embodiments, touch-sensor controller 12 comprises analog circuitry, digital logic, and digital non-volatile memory. In particular embodiments, touch-sensor controller 12 is disposed on a flexible printed circuit (FPC) bonded to the substrate of touch sensor 10, as described below. The FPC may be active or passive, where appropriate. In particular embodiments, multiple touch-sensor controllers 12 are disposed on the FPC. Touch-sensor controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular touch-sensor controller having a particular implementation with particular components, this disclosure contemplates any suitable touch-sensor controller having any suitable implementation with any suitable components.

Tracks 14 of conductive material disposed on the substrate of touch sensor 10 may couple the drive or sense electrodes of touch sensor 10 to connection pads 16, also disposed on the substrate of touch sensor 10. As described below, connection pads 16 facilitate coupling of tracks 14 to touch-sensor controller 12. Tracks 14 may extend into or around (e.g. at the edges of) the touch-sensitive area(s) of touch sensor 10. Particular tracks 14 may provide drive connections for coupling touch-sensor controller 12 to drive electrodes of touch sensor 10, through which the drive unit of touch-sensor controller 12 may supply drive signals to the drive electrodes. Other tracks 14 may provide sense connections for coupling touch-sensor controller 12 to sense electrodes of touch sensor 10, through which the sense unit of touch-sensor controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (which may be a connection pad 16) at an edge of the substrate of touch sensor 10 (similar to tracks 14).

Connection pads 16 may be located along one or more edges of the substrate, outside the touch-sensitive area(s) of touch sensor 10. As described above, touch-sensor controller 12 may be on an FPC. Connection pads 16 may be made of the same material as tracks 14 and may be bonded to the FPC using an anisotropic conductive film (ACF). Connection 18 may include conductive lines on the FPC coupling touch-sensor controller 12 to connection pads 16, in turn coupling touch-sensor controller 12 to tracks 14 and to the drive or sense electrodes of touch sensor 10. In another embodiment, connection pads 16 may be connected to an electro-mechanical connector (such as a zero insertion force wire-to-board connector); in this embodiment, connection 18 may not need to include an FPC. This disclosure contemplates any suitable connection 18 between touch-sensor controller 12 and touch sensor 10.

Particular embodiments of the present disclosure include a thin dielectric layer providing a protective coating over conductive material formed on a substrate of a stack of a touch sensor 10. The thin dielectric layer may be formed by applying a thin coating of a dielectric material over the substrate and conductive material before they are integrated with the other components of the stack. The thin dielectric layer protects the conductive material on the substrate during manufacturing of the touch sensor and thereafter. As an example, a thin dielectric layer may be placed on a top surface of a substrate and the conductive material formed on the substrate. A cover panel is then formed on the thin dielectric layer using an IML process. In the absence of the thin dielectric layer, the high pressure and high temperature resin that is injected (or otherwise applied) during the IML process would likely result in damage to the conductive material formed on the substrate. For example, the resin applied during the IML process may wash away the conductive material on the substrate. The thin dielectric layer provides a hard coat of protection that can withstand the high pressure and high temperature resin, such that the conductive material underneath the thin dielectric layer remains intact throughout the IML process. In typical solutions, a layer of optically clear adhesive and a protective carrier are laminated to the substrate and conductive material formed thereon before the IML process. While this method may protect the conductive material formed on the substrate, it involves extra processing steps (such as alignment of the protective carrier with the substrate) and materials that are not necessary if a thin dielectric layer is used instead. A thin dielectric layer is further preferable because it is much thinner than an adhesive layer and protective carrier (the adhesive layer alone may be approximately 50 microns thick while the thin dielectric layer is generally between about 0.5 microns and about 50 microns thick). Accordingly, a touch screen with a thin dielectric layer may be more responsive to touches because the sensors (implemented by the conductive material formed on the substrate) of the touch screen are positioned closer to the top of the cover panel where the touches occur.

A thin dielectric layer may also be placed over a bottom surface of a substrate and conductive material formed on the bottom surface of the substrate. The thin dielectric layer may be used in place of a layer of adhesive and a protective cover layer, thus resulting in a thinner stack. The thin dielectric layer may also be cheaper and easier to apply than the layer of adhesive and the dielectric layer. The thin dielectric layer can also provide protection (during and after the manufacturing process) against corrosion (e.g. rust) to the conductive elements formed on the substrate.

FIG. 2a illustrates an example thin dielectric layer 20a formed on a top surface of an example substrate 22 with conductive material forming electrodes 24. As depicted, thin dielectric layer 20a is formed over drive electrodes 24a. The thin dielectric layer 20a may also overlay and protect any other suitable conductive elements of touch sensor 10, such as sense electrodes 24b, drive lines, sense lines, tracks 14, or connection pads 16.

In the embodiment depicted, thin dielectric layer 20a forms a substantially flat sheet over substrate 22. That is, the top surface of thin dielectric layer 20a maintains a uniform thickness with respect to the top surface of substrate 22. Such embodiments may allow a thin dielectric layer 20 to interface with other flat elements of a touch sensor stack, such as a cover panel formed by an IML process or a layer of adhesive placed between thin dielectric layer 20 and a cover panel or display panel. In another embodiment, thin dielectric layer 20a generally conforms with the shape of substrate 22 and the conductive material formed thereon. For example, a portion of the thin dielectric layer 20a that contacts the top surface of substrate 22 may rest lower than another portion of the thin dielectric layer that overlays a drive electrode 24a that is raised from the surface of the substrate. In such embodiments, each point of the thin dielectric layer 20a may have a generally constant thickness when measured from the element (e.g. substrate 22 or drive electrode 24a) contacted by the thin dielectric layer at that point.

The thin dielectric layer 20a is formed by applying a thin coating of a dielectric material over the substrate and conductive material formed thereon. The thin dielectric layer 20a may have any suitable thickness, such as between about 0.5 and about 50 microns. In various embodiments, the thin dielectric layer 20a is less than 10 microns. In a particular embodiment, the thin dielectric layer 20a is between about 0.5 and about 4 microns. The thin dielectric layer 20a may include any dielectric material with suitable physical characteristics, such as good adhesion (to substrate 22 and a cover panel), durability, and suitable optical properties (e.g. the material should be clear so that a display panel can be viewed through the thin dielectric layer 20a). When an IML process is used to form the cover panel, the material should also have a melting point that is high enough to provide adequate protection against washout when the high temperature resin is applied during IML. The material should also be suitable for application in a thin layer, such as less than 10 microns in thickness. Examples of suitable materials for forming thin dielectric layer 20a include varnish, shellac, lacquer, PMMA, or polycarbonate.

In particular embodiments, the dielectric material may be chosen to index match the material of the cover panel. This may include choosing a dielectric material with optical properties that are similar to optical properties of the cover panel in order to minimize visual distortions (such as rainbow effects) that can arise from dissimilarities between the cover panel and the thin dielectric layer 20a. In one embodiment, index matching is achieved by forming a thin dielectric layer 20a made of the same material as the cover panel. For example, the thin dielectric layer 20a may be made of PMMA and the cover panel formed by injecting PMMA resin during an IML process.

The dielectric material may be formed on the substrate 22 and conductive material in any suitable manner. In a particular embodiment, a roll-to-roll process is used to apply the dielectric material to substrate 22 and the conductive material formed thereon. In such an embodiment, a roll may include a plurality of segments that each include a discrete substrate 22 and conductive material. Another roll may include a thin film of dielectric material. The dielectric material from this roll may be laminated or otherwise applied to the segments of the first roll, resulting in the formation of thin dielectric layers 20 on substrates 22 and the conductive materials formed thereon. In various embodiments, when the dielectric layer 20 is formed on substrate 22 using this method, dielectric layer 20 has a thickness between about 0.5 microns and about 4 microns.

In some embodiments, the dielectric material is applied in a liquid (or semi-liquid or other malleable) form and allowed to cure into a hard protective coating over substrate 22 and the conductive material. Any suitable method may be used to apply the dielectric material to the substrate 22. For example, the dielectric material may be screen printed on the substrate 22 and the conductive material. As another example, a roller or brush may be used to coat the dielectric material on the substrate 22 and conductive material. As another example, the substrate 22 and conductive material may be immersed in and then removed from a pool of the dielectric material. As yet other examples, the dielectric material may be sprayed, poured, or inkjet printed onto substrate 22 and the conductive material. In various such embodiments, dielectric layer 20 has a thickness between about 2 microns and about 50 microns.

The thin dielectric layer 20a may be formed at any suitable time during manufacturing of touch sensor 10. For example, the thin dielectric layer 20a may be formed immediately or soon after the conductive material is formed on substrate 22. In particular embodiments, a series of substrates may be processed in succession. Conductive material is formed on one substrate, a thin dielectric layer is then formed on that substrate, conductive material is formed on the next substrate, a thin dielectric layer is formed on that substrate, and so on. Such a method may be relatively fast and inexpensive compared to other solutions where a layer of adhesive and other component (such as a protective carrier or dielectric layer) has to be aligned with and applied to the substrate. Once the thin dielectric layer 20a is formed, it protects against corrosion (e.g. rust) of the conductive material that can occur if the substrate and conductive material is exposed to moisture or other corrosion facilitating material.

FIG. 2b illustrates a display 32 and a stack 34 of touch sensor 10 that incorporates the thin dielectric layer 20a of FIG. 2a. Stack 34 includes electrodes 24 formed on substrate 22, a cover panel 26a formed over thin dielectric layer 20a via an IML process, a layer of adhesive 28, and a protective cover layer 30 (such as a hard coat of PET). The protective cover layer 30 faces display panel 32 with an air gap between the protective cover layer 30 and display panel 32. In alternative embodiments, a layer of adhesive 28 may be placed between substrate 22 and display panel 32 in the place of an adhesive layer, a protective cover layer, and an air gap. Display panel 32 may be a liquid crystal display (LCD), light emitting diode (LED) display, or other suitable electronic display.

During manufacturing of stack 34, thin dielectric layer 20a is formed on substrate 22 and the conductive materials (e.g. electrodes 24a). The resulting structure is then presented to an IML tool. The IML tool applies a suitable material (such as a substantially clear resin) onto the top of thin dielectric layer 20a at a high temperature. As the material cools, it hardens and adheres to the thin dielectric layer 20a, forming cover panel 26a. Any suitable material may be used to form cover panel 26a, such as PMMA, polycarbonate, or other material with proper adhesive and optical properties.

FIG. 3a illustrates a thin dielectric layer 20b formed on a bottom surface of a substrate 22 with conductive material forming electrodes 24. In general, the thin dielectric layer 20b may include any of the characteristics described above in connection with thin dielectric layer 20a. As depicted, thin dielectric layer 20b is formed over sense electrodes 24b. The thin dielectric layer 20b on the bottom surface of substrate 22 may overlay and protect any other suitable conductive elements of touch sensor 10, such as sense lines, tracks 14, or connection pads 16.

As described above in connection with thin dielectric layer 20a, thin dielectric layer 20b may form a substantially flat sheet over the substrate 22 or may generally conform with the shape of the substrate 22 and conductive material formed thereon (such as sense electrodes 24b). The thin dielectric layer 20b may be formed of any suitable material and in any suitable manner, such as that described above in connection with thin dielectric layer 20a. In particular embodiments, a material used to form thin dielectric layer 20b on the bottom of a substrate 22 may be different from a material used to form a thin dielectric layer 20a on the top of a substrate 22, since the material on the bottom of the substrate will not be subjected to the application of the IML material. Thus, constraints on adhesion, melting point, and durability may be loosened for a dielectric material applied to the bottom surface of a substrate, though the material should still have excellent optical properties. Thin dielectric layer 20b on the bottom surface of the substrate 22 may also be formed immediately or soon after the conductive material is formed on substrate 22 in order to protect the conductive material during manufacturing. In particular embodiments, thin dielectric layers 20a and 20b may be formed concurrently. FIG. 3b illustrates a display 32 and a stack 36 of touch sensor 10 that incorporates the thin dielectric layer 20b of FIG. 3a. Stack 36 includes electrodes 24 formed on substrate 22, a cover panel 26b coupled to substrate 22 via a layer of adhesive 28, and thin dielectric layer 20b applied to the bottom surface of substrate 22 and conductive material formed thereon. The thin dielectric layer 20b is configured to interface with display panel 32. For example, as depicted, the thin dielectric layer 20b may face display panel 32 with an air gap 31 between thin dielectric layer 20b and display panel 32. In such embodiments, the dielectric layer may be sufficiently thick (e.g. greater than or equal to about 2 microns) and smooth such that visual interference effects (such as rainbow effects) are avoided or mitigated.

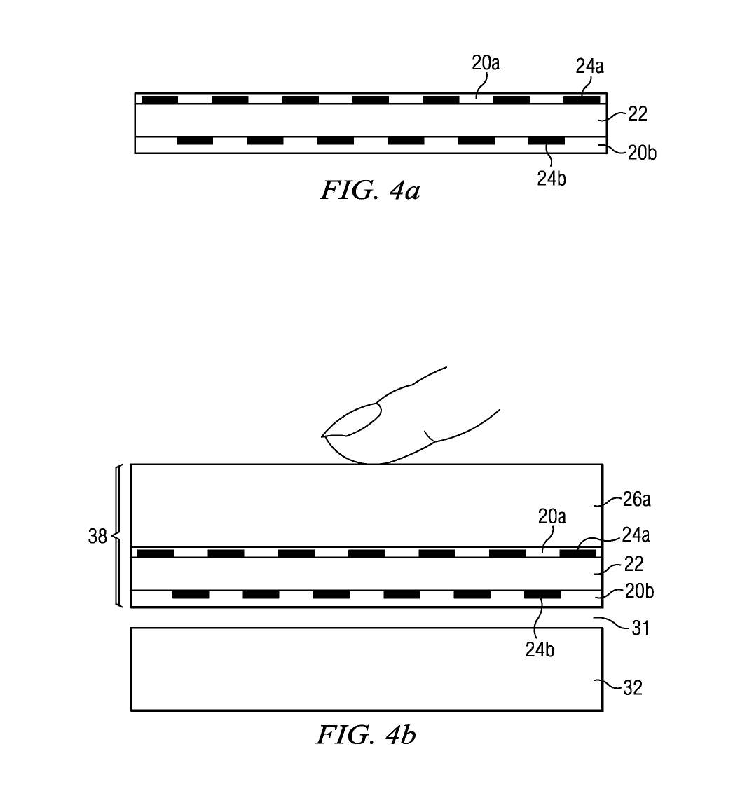

FIG. 4a illustrates thin dielectric layers 20a and 20b formed on the top and bottom surfaces of substrate 22 with conductive material forming electrodes 24. Thin dielectric layers 20a and 20b of FIG. 4a may have any of the characteristics described above in connection with the thin dielectric layers of FIGS. 2 and 3. In the embodiment depicted, thin dielectric layer 20a has a thickness that is smaller than the thickness of thin dielectric layer 20b. In particular embodiments, thin dielectric 20b may be formed using a process that is different from a process used to form thin dielectric layer 20a. As an example, and not by way of limitation, thin dielectric layer 20a may be formed by a roll-to-roll process and thin dielectric layer 20b may be formed by a screen printing process. In other embodiments, thin dielectric layers 20 may have substantially the same thickness or be formed using the same process.

FIG. 4b illustrates a display 32 and a stack 38 of touch sensor 10 that incorporates the thin dielectric layers 20 of FIG. 4a. Stack 38 includes electrodes 24 formed on substrate 22, thin dielectric layers 20a and 20b formed on the top and bottom surfaces of substrate 22 and the electrodes 24, and a cover panel 26a formed over thin dielectric layer 20a via an IML process. The thin dielectric layer 20b is configured to interface with display panel 32. For example, as depicted, the thin dielectric layer 20b may face display panel 32 with an air gap 31 between thin dielectric layer 20b and display panel 32.

Although example stack configurations have been shown, thin dielectric layers 20 may be applied within a stack of a touch sensor 10 in any suitable manner. As examples, a thin dielectric layer 20 may be applied to the top surface of the top substrate of multiple substrates, to the bottom surface of the bottom substrate of multiple substrates, or both.

In particular embodiments, a thin dielectric layer 20 is applied to only a portion of a surface of substrate 22. As an example, the thin dielectric layer 20 may be omitted from the area of the substrate 22 on which the connection pads 16 are formed, so as not to interfere with coupling between controller 12 and the connection pads. In other embodiments, the thin dielectric layer 20 is applied to the portion of substrate 22 that includes the connection pads 16, but portions of the thin dielectric layer are subsequently removed from the connection pads 16 in order to expose at least a portion of the connection pads 16. Portions of the thin dielectric layer 20 may be removed in any suitable manner, such as through application of a solvent. In yet other embodiments, thin dielectric layer 20 may be applied to the portion of substrate 22 that includes the connection pads 16, but the thin dielectric layer is sufficiently thin (e.g. about 0.5-4 microns) to allow ACF to penetrate through the thin dielectric layer 20 during bonding between the connection pads 16 and an FPC.

FIG. 5 illustrates an example method for forming a stack of a touch sensor 10 with one or more thin dielectric layers 20. The method begins as substrate 22 is formed at step 50. Substrate 22 may be formed in any suitable manner and, as discussed earlier, may comprise PET. At step 52, conductive material is formed on substrate 22. The conductive material may be formed on any suitable surface of the substrate 22. Any suitable conductive elements may be formed from the conductive material, such as tracks 14, connection pads 16, drive electrodes 24a, sense electrodes 24b, drive lines, or sense lines. The conductive elements may be made of any suitable material such as FLM, ITO, or carbon nanotubes.

At step 54, a thin protective coating is applied to the substrate 22 with the conductive material. For example, thin dielectric layer 20 may be formed over a surface of the substrate 22 (including the conductive material). The thin dielectric layer 20 may be formed over any suitable portion or all of one or more surfaces of the substrate 22. In particular embodiments that include multiple substrates in a stack, thin dielectric layers 20 are formed on the top surface of the top substrate and the bottom surface of the bottom substrate. After a thin dielectric layer 20 is formed, unwanted portions of the thin dielectric layer 20 may be removed. As an example, dielectric material placed over connection pads 16 may be removed.

At optional step 56, graphics are printed on substrate 22. As an example, a company logo or other indicia may be screen printed on substrate 22. In some embodiments, the graphics may cover tracks 14 that would otherwise be visible. At step 58, the substrate 22 is cut to the desired size. The substrate may be cut in any suitable manner. At step 60, cover panel 26 is applied to the substrate 22 with conductive material. In particular embodiments, the cut substrate 22 is presented to an IML tool and the cover panel 26 is formed over a thin dielectric layer 20a on the top surface of the substrate. In other embodiments, a separately manufactured cover panel 26 is applied to the top surface of the substrate via an adhesive layer 28.

Particular embodiments may repeat the steps of the method of FIG. 4, where appropriate. Moreover, although this disclosure describes and illustrates particular steps of the method of FIG. 4 as occurring in a particular order, this disclosure contemplates any suitable steps of the method of FIG. 4 occurring in any suitable order. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

Particular embodiments of the present disclosure may provide one or more or none of the following technical advantages. In particular embodiments, a thin dielectric layer may protect conductive material formed on a substrate from being damaged during formation of a cover panel using an IML process. Some embodiments may provide a thinner touch sensor stack resulting in improved accuracy in detecting touches on a cover panel of the stack and increased window mold quality. Particular embodiments may facilitate relatively inexpensive and efficient manufacturing of touch sensor stacks.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A touch sensor comprising:
a substrate comprising a first surface;
a plurality of electrodes comprising one or more conductive materials formed on the first surface of the substrate;
a dielectric layer formed on the plurality of electrodes and at least a portion of the first surface of the substrate, with no adhesive layer between the dielectric layer and the plurality of electrodes; and
a substantially transparent cover panel disposed on the dielectric layer through an in-mold lamination process.

2. The touch sensor of claim 1, wherein the dielectric layer has a thickness that is between about 0.5 microns and about 4 microns.

3. The touch sensor of claim 1, wherein the dielectric layer has a thickness that is between about 10 microns and about 50 microns.

4. The touch sensor of claim 1, wherein the dielectric layer comprises substantially transparent lacquer, poly(methyl methacrylate), or polycarbonate.

5. The touch sensor of claim 1, wherein the dielectric layer is formed by:
screen printing a dielectric material on the substrate and the plurality of electrodes;
applying a first segment of a first roll to a second segment of a second roll in a roll-to-roll process, the first segment of the first reel comprising the dielectric material and the second segment of the second reel comprising the substrate and the plurality of electrodes;
spraying the dielectric material on the substrate and the plurality of electrodes;
inkjet printing the dielectric material on the substrate and the plurality of electrodes; or
immersing the substrate and the plurality of electrodes in the dielectric material.

6. The touch sensor of claim 1, the one or more conductive materials comprising indium tin oxide, a plurality of fine lines of metal, or a plurality of carbon nanotubes.

7. The touch sensor of claim 1, wherein the plurality of electrodes is a first plurality of electrodes, the substrate is a first substrate, and the dielectric layer is a first dielectric layer, the touch sensor further comprising:
a second plurality of electrodes comprising one or more conductive materials formed on a second surface of the first substrate or a second substrate; and
a second dielectric layer formed over at least a portion of the second surface of the first or second substrate and the second plurality of electrodes with no adhesive layer between the second dielectric layer and the second plurality of electrodes.

8. The touch sensor of claim 7, the second dielectric layer having a thickness that is approximately equal to a thickness of the first dielectric layer.

9. The touch sensor of claim 7, wherein the second dielectric layer faces the electronic display panel with an air gap between the second dielectric layer and the electronic display panel.

10. The touch sensor of claim 7, the second dielectric layer shaped such that it does not contact a plurality of connection pads formed on the second surface of the first or second substrate, the plurality of connection pads configured to couple a plurality of drive lines or sense lines of the touch sensor to a touch-sensor controller comprising one or more computer-readable non-transitory storage media embodying logic that is configured when executed to control the touch sensor.

11. The touch sensor of claim 10, the second dielectric layer having a thickness that is between about 2 microns and about 50 microns.

12. A touch sensor comprising:
a substrate comprising a first surface;
a plurality of electrodes comprising one or more conductive materials formed on the first surface of the substrate; and
a dielectric layer formed over the plurality of electrodes and at least a portion of the first surface of the substrate, with no adhesive layer between the dielectric layer and the plurality of electrodes, the dielectric layer configured to face an electronic display panel with an air gap between the dielectric layer and the electronic display panel.

13. The touch sensor of claim 12, the dielectric layer comprising substantially clear lacquer, poly(methyl methacrylate), or polycarbonate.

14. The touch sensor of claim 12, wherein:
the dielectric layer has a thickness that is between about 2.0 microns and about 50 microns; and
a surface of the dielectric layer that does not contact the substrate is substantially flat.

15. The touch sensor of claim 12, wherein the plurality of electrodes is a first plurality of electrodes, the substrate is a first substrate, and the dielectric layer is a first dielectric layer, the touch sensor further comprising:
a second plurality of electrodes comprising one or more conductive materials formed on a second surface of the first substrate or a second substrate; and
a substantially transparent cover panel affixed to the second surface of the first or second substrate with a layer of optically clear adhesive.

16. The touch sensor of claim 10, the one or more conductive materials comprising indium tin oxide, a plurality of fine lines of metal, or a plurality of carbon nanotubes.

17. A method for forming a touch sensor, the method comprising:
providing a substrate comprising a first surface;
forming a plurality of electrodes comprising one or more conductive materials on the first surface of the substrate; and
forming a dielectric layer on the plurality of electrodes and at least a portion of the first surface of the substrate, with no adhesive layer between the dielectric layer and the plurality of electrodes.

18. The method of claim 17, further comprising injecting a liquid resin into an in mold lamination tool, which forces the liquid resin against the dielectric layer to form a substantially transparent cover panel.

19. The method of claim 17, further comprising attaching a display panel to the substrate such that an electronic display panel faces the dielectric layer, with an air gap disposed between the dielectric layer and the display panel.

20. The method of claim 17, wherein the plurality of electrodes is a first plurality of electrodes, the substrate is a first substrate, and the dielectric layer is a first dielectric layer, the method further comprising:
forming a second plurality of electrodes comprising one or more conductive materials on a second surface of the first substrate or a second substrate; and
applying a second dielectric layer over the second plurality of electrodes and at least a portion of the second surface of the first or second substrate, with no adhesive layer between the second dielectric layer and the second surface of the first or second substrate.

21. A device comprising:
a touch sensor comprising:
a substrate comprising a first surface;
a plurality of electrodes comprising one or more conductive materials formed on the first surface of the substrate;
a dielectric layer formed on the plurality of electrodes and at least a portion of the first surface of the substrate, with no adhesive layer between the dielectric layer and the plurality of electrodes; and
a transparent cover panel disposed on the dielectric layer through an in-mold lamination process; and
one or more computer-readable non-transitory storage media coupled to the touch sensor and embodying logic that is configured when executed to control the touch sensor.
